(19) United States
(12) Patent Application Publication
(10) Pub. No.: US 2026/0118313 A1
(43) Pub. Date: Apr. 30, 2026

(54) PROTEIN POLYACRYLAMIDE GEL ELECTROPHORESIS-ONLINE INTRINSIC FLUORESCENCE IMAGING ANALYSIS DEVICE AND METHOD

(71) Applicant: BioChine Technology (Suzhou) Co., Ltd., Shanghai (CN)

(72) Inventors: Chengxi CAO, Shanghai (CN); Zixian YU, Shanghai (CN); Jianguang WU, Shanghai (CN); Xiaoping LIU, Shanghai (CN); Changjie YU, Shanghai (CN); Wenxin DAI, Shanghai (CN)

(73) Assignee: BioChine Technology (Suzhou) Co., Ltd., Shanghai (CN)

(21) Appl. No.: 19/431,907

(22) Filed: Dec. 23, 2025

Related U.S. Application Data
(63) Continuation of application No. PCT/CN2024/085850, filed on Apr. 3, 2024.

(30) Foreign Application Priority Data
Jun. 29, 2023 (CN) 202310785316.5

(51) Int. Cl. G01N 27/447; G01N 21/64; G01N 27/453

(52) U.S. Cl. CPC G01N 27/44721; G01N 21/6456; G01N 27/453

(57) ABSTRACT

The present invention relates to a protein polyacrylamide gel electrophoresis (PAGE)-online intrinsic fluorescence imaging analysis device and method. The device is used for protein electrophoresis separation and online imaging detection of protein bands. The device includes: an open electrophoresis tank including an upper buffer chamber located in the upper part of the open electrophoresis tank, and a lower buffer chamber located in the lower part of the open electrophoresis tank; a UV light source used to excite protein bands in the gel to generate intrinsic fluorescence signals; a CCD imaging detection mechanism including a filter positioned at the front end of the CCD imaging detection device, a UV lens arranged between the filter and the CCD sensor, and a CCD sensor connected to a control unit; a control unit connected to the CCD sensor for online intrinsic fluorescence imaging.

### CROSS-REFERENCE TO RELATED APPLICATION

This application is a continuation of international application of PCT application serial no. PCT/CN2024/085850 filed on Apr. 3, 2024, which claims the priority benefit of China application no. 202310785316.5 filed on Jun. 29, 2023. The entirety of each of the above mentioned patent applications is hereby incorporated by reference herein and made a part of this specification.

### BACKGROUND

### Technical Field

The present invention relates to the technical field of protein polyacrylamide gel electrophoresis, and particularly to a protein polyacrylamide gel electrophoresis-online intrinsic fluorescence imaging analysis device and method.

### Description of Related Art

Currently, the most commonly-used technique for protein separation in bio-labs is slab polyacrylamide gel electrophoresis (PAGE) for both protein and nucleic acid separation. However, traditional PAGE analysis devices and methods suffer from several limitations that significantly restrict their applications:

1. A cumbersome, reagent-intensive and time-consuming post-electrophoresis staining-destaining processing involving multiple steps:
Post-electrophoresis gel removal;
More than 30 minutes of protein fixation in fixing solution;
More than 60 minutes of staining with dye reagents;
More than 60 minutes of destaining with repeated destaining solution changes (Chang Shenghe et al., Advances in Methods of Protein Bands Staining on SDS-PAGE [J]. Journal of Henan Agricultural Sciences, 2006, (5): 8-12).

### 2. Lack of Real-Time Imaging Function

Traditional electrophoresis tanks feature fully enclosed structures with ordinary front glass or transparent plastic plate that blocks UV transmission. Thus, the electrophoresis tank housing and conventional front glass or transparent plastic plate severely affect UV optical signal acquisition. Consequently, protein detection within the gel necessitates post-electrophoresis gel removal for staining, external imaging scanners for stained protein bands; and additional image processing software for grayscale analysis.

### 3. Low Resolution

Proteins undergo continuous Brownian motion within the gel. Protein band diffusion within gel occurs immediately after electrophoresis cessation and during gel handling for fixation/staining, leading deteriorate protein band and low resolution.

### 4. Non-Traceable Data

Conventional platforms rely on manual operation and data recording, raising risks of data fabrication, uncontrolled data sources or misuse of experimental results.

### 5. No Quantitative Detection

current staining techniques of PAGE cannot provide quantitative measurement of protein mass in the analyzed bands. The staining intensity only approximately reflects relative protein amounts, failing to accurately determine the absolute protein mass within each band (Lin F. Y., et al. Comparison of Several SDS-PAGE Gel Electrophoresis Staining Methods [J]. Journal of Anhui Agricultural Sciences, 2014, 42 (8), 2295-2296.)

In view of the limitations of conventional protein gel electrophoresis, it is critically important to develop an integrated protein gel electrophoresis-online intrinsic fluorescence detection device. Studies have revealed that most proteins intrinsically contain fluorophores which emit fluorescence under an UV point light source-based excitation, with the fluorescence intensity exhibiting a positive correlation with protein mass (Li, Q., et al., Autofluorescence Detection in Analytical Chemistry and Biochemistry [J]. Applied Spectroscopy Reviews, 2010, 45 (1), 12-43.). This establishes UV-induced protein fluorescence detection as a highly promising label-free quantitative technique. However, the UV point light source-based excitation of protein intrinsic fluorescence is propitious to the online end-point detection, like capillary zone electrophoresis, liquid chromatography and gas chromatography, rather than the imaging detection. In addition, the fluorescence intensity of the UV-excited proteins is weak and susceptible to environmental interference. Particularly, the plastic materials used in conventional slab PAGE systems also produce much strong fluorescence under UV excitation, which completely conceals the detection signal of protein intrinsic fluorescence. Evidently, traditional gel electrophoresis is incompatible with UV end light source-based protein fluorescence intensity detection methods. Therefore, there is currently a lack of key technologies and core components to combine UV-excited protein fluorescence imaging with PAGE electrophoresis, greatly hindering its practical application and development.

### SUMMARY

The present invention aims to address the aforementioned issues by providing a protein polyacrylamide gel electrophoresis-online intrinsic fluorescence imaging analysis device and method, featuring an open electrophoresis tank capable of real-time monitoring of protein migration during a run of electrophoresis, direct acquisition of electrophoretic bands of proteins without manual post-processing of protein staining-destaining-imaging, automatic quantitative detection of target proteins, reduced reagent consumption, and simplified experimental procedures.

### Technical Solution

The first objective of the invention is to provide a protein polyacrylamide gel electrophoresis-online intrinsic fluorescence imaging analysis device for protein electrophoretic separation and online detection of imaging.

The device includes:
An open electrophoresis tank, serving as both an electrophoresis chamber and a window of UV intrinsic fluorescence imaging detection of protein bands, including an upper buffer chamber positioned at the upper part of the open electrophoresis tank and a lower buffer chamber positioned at the lower part of the open electrophoresis tank;
A UV area light source for exciting protein bands within the gel to generate intrinsic fluorescence signals;
A CCD imaging detection unit for capturing intrinsic fluorescence signals from protein bands during electrophoresis, including a filter positioned at the front end of the CCD imaging detection unit, a UV lens positioned between the filter and the CCD sensor, a CCD sensor connected to the online analysis host and a host connected to the CCD sensor for real-time imaging;
The gel is a slab gel.

### Further Features:

The housing of the open electrophoresis tank is made of black light-absorbing material.

Suitable materials of the open electrophoresis tank include, but are not limited to black PMMA, black PC, black PVC, black PP, or black PTFE.

The upper buffer chamber includes symmetrically placed positive and negative electrodes and slab gel slots arranged front-to-back.

The slab gel slot includes fixing wedges, a plate structure consisting of (in order) the front quartz glass, the middle slab gel and the back background plate.

The back background plate is made of materials including, but not limited to glass, polyethylene, polystyrene, PTFE, or polycarbonate.

The UV light source has a central wavelength of 275-360 nm and includes, but is not limited to LEDs, deuterium lamps, mercury lamps, or laser sources. Emission types: point, line, or area sources.

The UV light source is symmetrically arranged on both sides of the detection surface. The CCD imaging detection unit is positioned on the front of slab gel located in the open electrophoresis tank.

The filter has the following properties:

Central wavelength: 250 nm-360 nm.

Peak transmittance: >80%.

FWHM (Full Width at Half Maximum): 10 nm-50 nm.

Preferred narrower FWHM: 10 nm-40 nm.

The UV lens has the following specifications:

Focal length: 35-39 mm.

Aperture: F #5.6.

Working distance: 150 mm-10 m.

Operating wavelength: 250-380 nm.

The CCD sensor has a quantum efficiency >40% at the central wavelength.

Second Objective is to provide a method for protein gel electrophoresis separation and online intrinsic fluorescence detection using the aforementioned protein polyacrylamide gel electrophoresis-online intrinsic fluorescence imaging analysis device. The method includes the following steps:

### Step 1: Gel Installation & Sample Loading

Mount the prepared slab gel into the slab gel slot of the upper buffer chamber.

Assemble the upper buffer chamber vertically onto the lower buffer chamber.

Add electrode buffer to both of anode and cathode chambers.

Load 1-20 μL of sample into the loading wells of the slab gel.

### Step 2: Electrophoresis Processing

Connect the power supply's electrodes to the upper buffer chamber.

Set voltage at 50-3000 V/m.

Run electrophoresis for 20-40 minutes.

### Step 3: Online Imaging & Analysis

Activate the UV light source during/after electrophoresis.

Use the CCD imaging detection unit for real-time imaging.

Monitor protein band migration via the host.

Obtain protein composition, molecular weight and concentration data.

The present invention not only enables real-time imaging detection of protein gel electrophoresis, but also achieves quantitative detection of protein bands without requiring complex post-processing procedures, such as manual fixation, staining, destaining and imaging of protein bands in gel.

Compared with existing technologies of protein gel electrophoresis, the advantages of this invention are reflected in the following aspects:

1. The protein polyacrylamide gel electrophoresis-online intrinsic fluorescence imaging analysis device and method proposed in this invention enables real-time online monitoring of the electrophoresis process. The open electrophoresis tank facilitates optical signal acquisition, allowing observation of protein bands during electrophoresis without subsequent time-consuming gel fixation, staining, destaining and imaging procedures.

2. The proposed device and method provide high resolution. Online detection prevents diffusion of protein bands within the gel, achieving higher separation resolution than conventional offline staining methods.

3. This invention realizes label-free protein detection without requiring fluorescence labeling and staining reagents, significantly saving detection time and costs.

4. The highly integrated automated system can automatically complete protein separation and detection. Only sample loading is required manually, while subsequent electrophoresis separation and imaging detection are automatically performed by the device and controlled through computer, completing the entire protein separation and detection process within 1 hour.

5. The system ensures traceable experimental data. Results are automatically uploaded to a database upon completion, recording key information including but not limit to operator name, sample, parameters and experiment time. Unauthorized personnel cannot modify any experimental results, guaranteeing data reliability.

6. The invention achieves instant quantitative protein detection. After electrophoresis completion, high-sensitivity CCD sensor acquires intrinsic fluorescence images of protein bands under UV excitation. Image processing technology is then applied to reduce background noise and establish a standard curve correlating fluorescence intensity with protein mass, thereby realizing quantitative protein detection.

### BRIEF DESCRIPTION OF THE DRAWINGS

FIG. 1 is a schematic structural diagram of the protein polyacrylamide gel electrophoresis (PAGE)-online intrinsic fluorescence imaging analysis device according to an embodiment of the present invention.

FIG. 2 is a schematic structural diagram of the upper buffer chamber in an embodiment of the present invention.

FIG. 3 is a schematic structural diagram of the slab gel cassette in an embodiment of the present invention.

FIG. 4 is a schematic diagram of the optical detection light path in an embodiment of the present invention.

FIG. 5 shows a comparison of imaging results for protein standard ladders using conventional front glass (a) versus front quartz glass (b) in an embodiment of the present invention.

FIG. 6 presents a comparison between fluorescence images of protein standard ladders and mixed protein samples with different masses obtained by the invention's online imaging method (a), versus results from Coomassie Brilliant Blue staining (b) (where: left—online imaging of present invention, right—Coomassie Brilliant Blue staining).

FIG. 7 demonstrates the separation resolution comparison for different molecular weight proteins in protein standard ladders between the present invention's online imaging method (a) and Coomassie Brilliant Blue staining (b) (where: left—online imaging of present invention, right—Coomassie Brilliant Blue staining).

FIG. 8 shows the separation resolution comparison for mixed protein samples with different masses between the present invention's online imaging method (a) and Coomassie Brilliant Blue staining (b) (where: left—online imaging of present invention, right—Coomassie Brilliant Blue staining).

FIG. 9 displays the standard curve correlating protein mass with fluorescence intensity in an embodiment of the present invention.

### KEY TO DIAGRAMS

1 Host computer
2 CCD sensor
3 UV lens
4 Optical filter
5 UV light source
6 Upper buffer chamber
7 Lower buffer chamber
8 Power supply
6.1 Fixing wedge
6.2 Slab structure
6.2.1 Quartz front glass
6.2.2 Slab gel
6.2.3 Black background plate
6.3 Positive/negative electrodes

### DESCRIPTION OF THE EMBODIMENTS

The following describes the invention in detail through specific embodiments, which are not to be construed as limiting the invention. Any preparation methods, materials, structures, or composition ratios not explicitly stated in this technical solution shall be regarded as conventional technical features disclosed in the prior art.

### EMBODIMENT

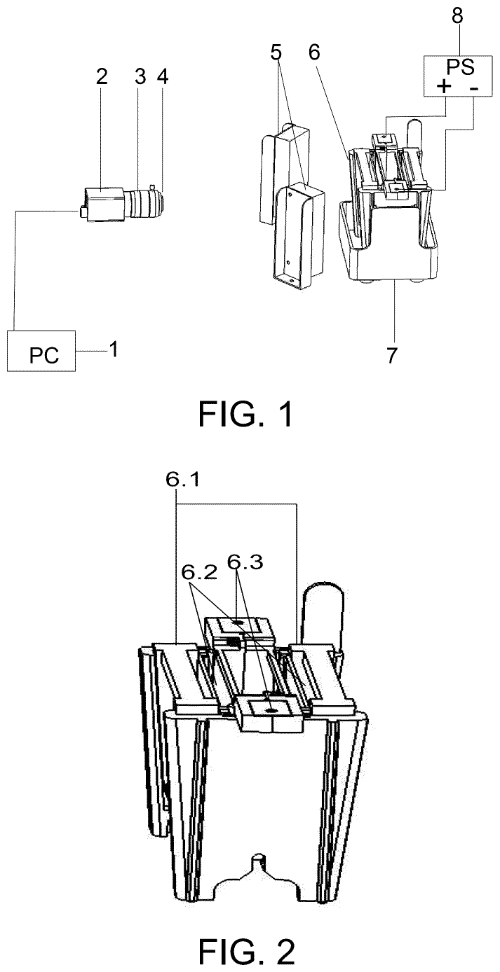

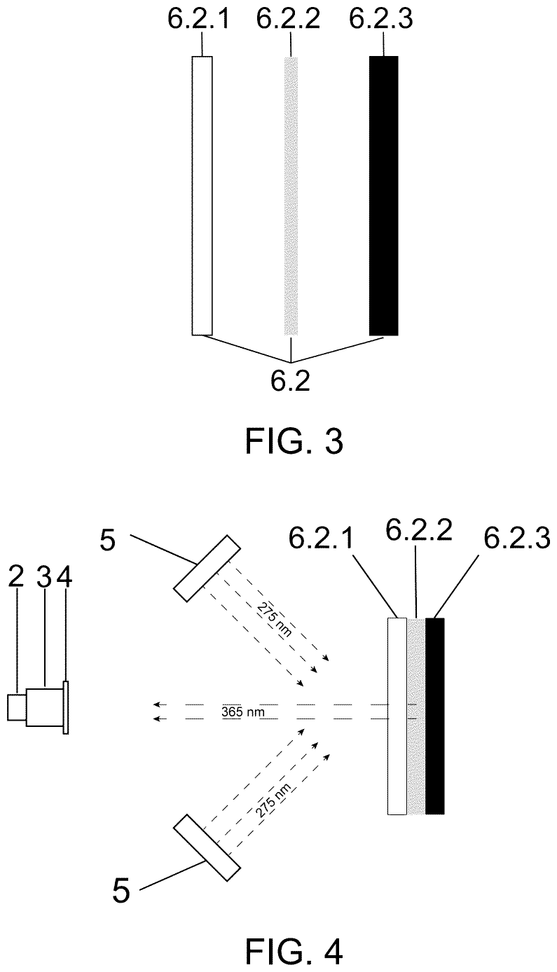

As shown in FIGS. 1-4, a protein polyacrylamide gel electrophoresis (PAGE) and online intrinsic fluorescence imaging analysis system and method include:
Host computer (1)
CCD sensor (2)
UV lens (3)
Optical filter (4)
UV light source (5)
Upper buffer chamber (6)
Lower buffer chamber (7)
Power supply (8)
Fixing wedge (6.1)
Front quartz glass (6.2.1)
Slab gel (6.2.2)
back background plate (6.2.3)
Positive/negative electrodes (6.3)

The specific connections are illustrated in the figures:

The host computer (1) is connected to the CCD sensor (2).

The CCD sensor (2), UV lens (3), and optical filter (4) are assembled to form a fluorescence imaging detection module.

The UV light source (5) irradiates the front quartz glass (6.2.1) of the upper buffer chamber (6) at a specific angle, allowing UV light to penetrate and excite protein bands in the gel of PAGE (6.2.2).

The upper buffer chamber (6) is placed on the lower buffer chamber (7).

The gel of PAGE (6.2.2) is prepared between the front quartz glass (6.2.1) and the back background plate (6.2.3) and secured in the slab gel slot of the upper buffer chamber (6) using the fixing wedge (6.1).

The conductor joints of positive and negative electrodes (6.3) in the upper buffer chamber (6) are connected to the power supply (8).

In the present embodiment, the UV light source (5) emits ultraviolet light with a central wavelength of 275 nm.

Load 10 μL of prepared protein sample into the wells of the slab gel (6.2.2).

Secure the gel of PAGE (6.2.2) in the slab gel slot and vertically place the upper buffer chamber (6) onto the lower buffer chamber (7).

Connect the power supply (8) and set the voltage to 80 V for 15 minutes, then increase to 120 V for another 20 minutes.

Activate the UV light source (5) to irradiate the gel area of PAGE (6.2.2) through the front quartz glass (6.2.1).

The conductor joints of positive/negative electrodes (6.3) on the upper buffer chamber (6) are connected to the power supply (8). After turning on the power supply (8) and adjusting to an appropriate voltage for protein electrophoresis separation, the UV light source (5) may be activated during electrophoresis to enable online imaging of protein bands.

Online intrinsic fluorescence imaging method for protein electrophoresis separation using above device specifically includes the following steps:
After loading samples into the loading wells, assemble the open electrophoresis tank and adjust the fluorescence sensing module to align the UV lens (3) with the imaging surface of the open electrophoresis tank;
Turn on the power supply (8) of the whole device, set the required voltage for electrophoresis separation, power on the host computer (1) and CCD sensor (2), adjust appropriate exposure time, and collect data in real-time;
During electrophoresis, activate the UV light source (5) to excite the protein bands within the gel. Under UV excitation, proteins emit intrinsic fluorescence signals that are captured by the CCD sensor (2) and displayed as corresponding protein fluorescence band patterns on the host computer (1), enabling real-time monitoring of the protein electrophoresis separation process;
Upon completion of electrophoresis, obtain the final protein intrinsic fluorescence band pattern, apply image processing techniques to reduce background noise, and determine grayscale values of protein fluorescence bands to achieve quantitative protein detection.

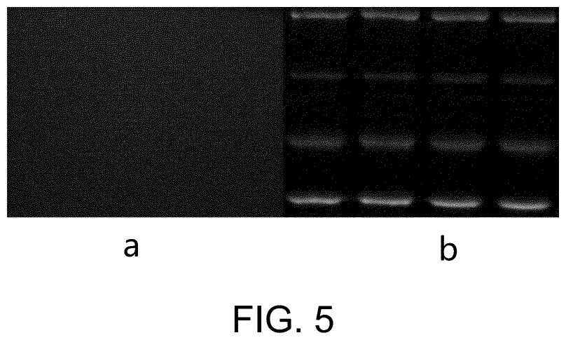

As shown in FIG. 5, conventional front glass or plastic blocks UV transmission, preventing excitation of protein intrinsic fluorescence in the gel of PAGE, resulting in no detectable fluorescence pattern (a of FIG. 5). The front quartz glass (6.2.1) in this embodiment demonstrates superior light transmission with high UV transmittance, allowing UV excitation light to effectively reach and excite intrinsic fluorescence of protein bands in the gel, enabling clear observation of protein fluorescence bands (b of FIG. 5).

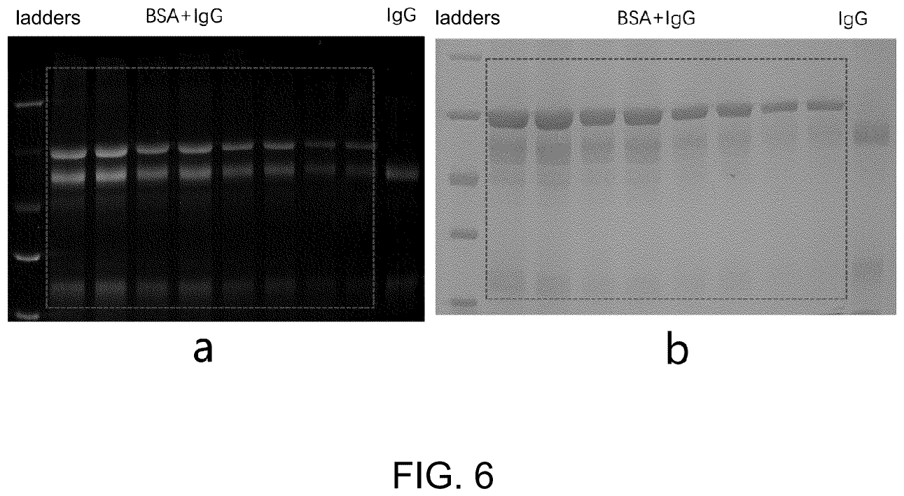

As shown in FIG. 6, for protein samples within dotted line frames, intrinsic fluorescence imaging shows higher sensitivity than CBB staining;

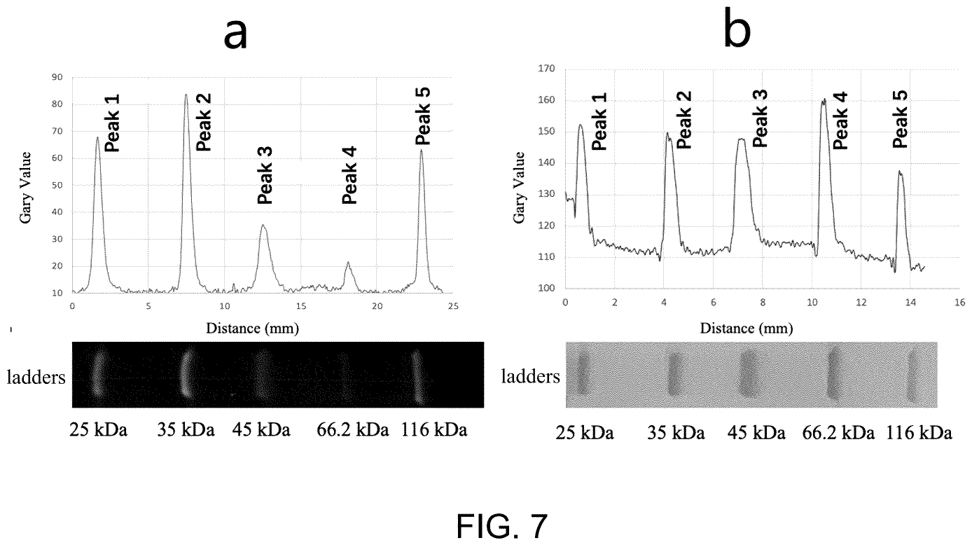

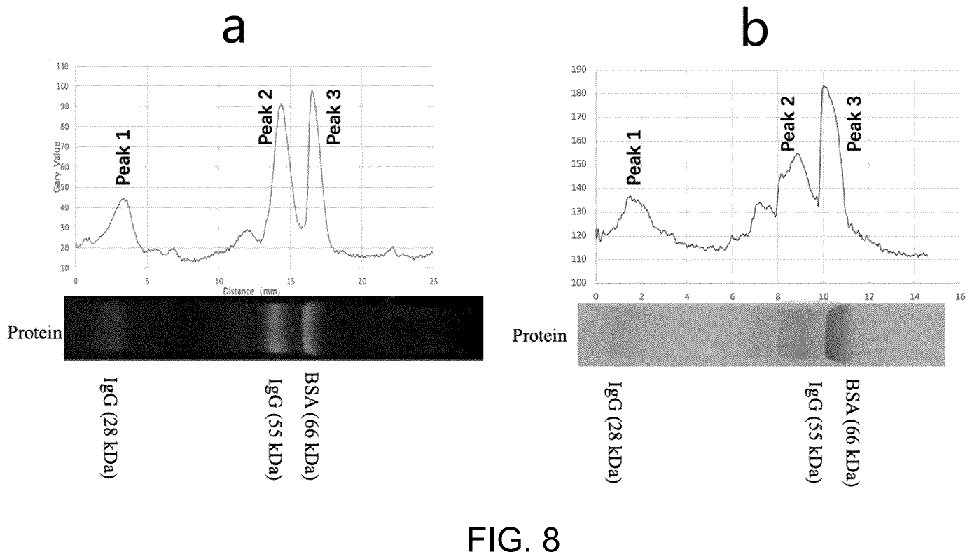

FIGS. 7-8: The device achieves significantly better resolution than CBB staining;

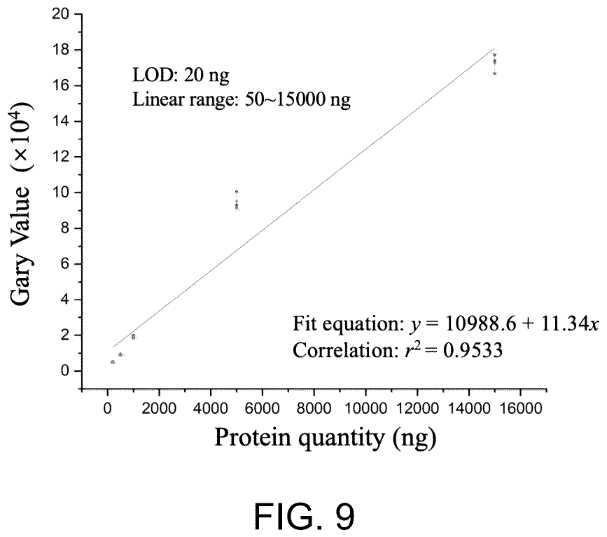

FIG. 9: The system enables quantitative analysis of protein bands with wide dynamic range and low detection limit.

The resolution comparison of different molecular weight proteins in protein standard molecular weight ladders and mixed protein samples is shown in Tables 1 and 2, respectively. For the protein standard ladders, where the protein bands have significant molecular weight differences, both methods successfully achieved separation. However, the resolution of the online imaging device was consistently superior to that of CBB staining. In the case of mixed protein samples with smaller molecular weight differences, the online imaging achieved a resolution of 1.6, whereas CBB staining failed to separate them effectively, yielding only 0.8 resolution. This clearly demonstrates that the online imaging resolution is significantly better than CBB staining.

TABLE 1
Resolution Comparison of Different Molecular Weight Proteins
in Protein Standard molecular weight ladders.

| Resolution | Online Imaging | CBB Staining |
|---|---|---|
| R₁ (Peak 1-2) | 7.6 | 4.9 |
| R₂ (Peak 2-3) | 4.4 | 3.3 |
| R₃ (Peak 3-4) | 4.3 | 4.1 |
| R₄ (Peak 4-5) | 5.6 | 5.4 |

TABLE 2
Resolution Comparison of Mixed Protein Sample

| Resolution | Online Imaging | CBB Staining |
|---|---|---|
| R₁ (Peak 1-2) | 4.8 | 4.2 |
| R₂ (Peak 2-3) | 1.6 | 0.8 |

The above description of embodiments is provided to enable any person skilled in the art to make and use the invention. Those skilled in the art will readily recognize that various modifications may be made to these embodiments, and the general principles defined herein may be applied to other implementations without departing from the inventive concept. Therefore, the present invention is not limited to the aforementioned embodiments. Any modifications or alternations made by those skilled in the art based on the disclosure of the present invention, without departing from the scope of the invention, shall fall within the protection scope of the present invention.

What is claimed is:

1. A protein polyacrylamide gel electrophoresis (PAGE)-online intrinsic fluorescence imaging analysis device, wherein the device is used for protein electrophoresis separation and online detection of intrinsic fluorescence;
the device comprises:
an open electrophoresis tank, serving as a support for precast gel of electrophoresis and as an open optical window for UV-excited intrinsic fluorescence imaging of protein bands, comprising:
an upper buffer chamber, located in the upper part of the open electrophoresis tank;
a lower buffer chamber, located in the lower part of the open electrophoresis tank;
a UV light source, used to excite protein bands in the gel to generate intrinsic fluorescence signals;
an optical sensor of CCD imaging detection, configured to capture intrinsic fluorescence signals from protein bands during electrophoresis for online imaging, comprising:
a filter, positioned at the front end of the CCD imaging sensor;
a UV lens, arranged between the filter and the CCD sensor;
a CCD sensor, connected to a control unit;
a control unit, connected to the CCD sensor for online imaging;
the gel is a precast polyacrylamide gel.

2. The protein polyacrylamide gel electrophoresis-online intrinsic fluorescence imaging analysis device according to claim 1, wherein the housing of the open electrophoresis tank is made of black light-absorbing material.

3. The protein polyacrylamide gel electrophoresis-online intrinsic fluorescence imaging analysis device according to claim 1, wherein the upper buffer chamber comprises symmetrically placed positive and negative electrodes on the left and right sides respectively, as well as slab precast gel slots arranged symmetrically front and back.

4. The protein polyacrylamide gel electrophoresis-online intrinsic fluorescence imaging analysis device according to claim 3, wherein the slab gel slots comprise:
a fixing wedge;
a slab structure, comprising, in sequence:
a quartz front glass;
a slab gel;
a black background plate.

5. The protein polyacrylamide gel electrophoresis-online intrinsic fluorescence imaging analysis device according to claim 1, wherein the UV light source has a central wavelength of 275 nm-360 nm.

6. The protein polyacrylamide gel electrophoresis-online intrinsic fluorescence imaging analysis device according to claim 1, wherein
the UV light source is symmetrically distributed on both sides of the detection surface of the open electrophoresis tank;
the CCD imaging sensor is positioned on the front of slab gel within the open electrophoresis tank.

7. The protein polyacrylamide gel electrophoresis-online intrinsic fluorescence imaging analysis device according to claim 1, wherein
the filter has a center wavelength of 250-360 nm with >80% transmittance at the center wavelength;
the bandwidth (FWHM) is 10 nm-50 nm.

8. The protein polyacrylamide gel electrophoresis-online intrinsic fluorescence imaging analysis device according to claim 1, wherein
the UV lens has:
a focal length of 35 mm-39 mm;
a working distance of 150 mm-10 m;
an operational wavelength range of 250-380 nm.

9. The protein polyacrylamide gel electrophoresis-online intrinsic fluorescence imaging analysis device according to claim 1, wherein
the CCD sensor has a quantum conversion efficiency >40% at the center wavelength.

10. A method for protein polyacrylamide gel electrophoresis-online intrinsic fluorescence imaging detection using the device according to claim 1, comprising the following steps:
step 1)
mounting the prepared slab gel in the upper buffer chamber;
vertically installing the upper buffer chamber onto the lower buffer chamber;
adding an appropriate amount of electrode buffer to both the upper and lower buffer chambers;
loading 1-20 μL of sample into the loading wells of the slab gel;
step 2)
connecting the upper buffer chamber to the positive/negative terminals of a power supply (8);
turning on the power supply and setting the voltage to 50 V/m-3000 V/m;
performing electrophoresis for 20-40 minutes;
step 3)
during/after electrophoresis:
activate the UV light source;
using the CCD imaging detection sensor to perform real-time imaging;
monitoring protein band migration via the control unit;
obtaining protein molecular weight and concentration data via standard molecular weight ladders and previously-prepared standard protein curve.
